(19) United States
(12) Patent Application Publication
(10) Pub. No.: US 2025/0097113 A1
(43) Pub. Date: Mar. 20, 2025

(54) POLICY-BASED MECHANISM TO MANAGE ACCESS TO SENSITIVE BOOTSTRAPPING DATA IN O-CLOUD

(71) Applicant: RAKUTEN SYMPHONY, INC., Tokyo (JP)

(72) Inventor: Krishna Pramod ADHARAPURAPU, Bangalore, KARNATAKA (IN)

(73) Assignee: RAKUTEN SYMPHONY, INC., Tokyo (JP)

(21) Appl. No.: 18/572,458

(22) PCT Filed: Nov. 24, 2023
(86) PCT No.: PCT/US2023/081032

§ 371 Date: Dec. 20, 2023

(30) Foreign Application Priority Data
May 12, 2023 (IN) 202341033689

(51) Int. Cl. H04L 41/0894; H04L 9/40

(52) U.S. Cl. CPC H04L 41/0894; H04L 63/1416

(57) ABSTRACT

Provided are a method, system, and apparatus for policy-based data management in an Open Radio Access Network (O-RAN) Cloud (O-Cloud) infrastructure. The method may include: storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and performing, by the O-Cloud infrastructure, the at least one action based on the data policy.

### TECHNICAL FIELD

System and methods consistent with example embodiments of the present disclosure relate to policy-based mechanisms for managing access to sensitive bootstrapping data, particularly with reference to open radio access network (O-RAN) cloud (O-Cloud).

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical Node for hosting Radio Resource Control (RRC), Service Data Adaptation Protocol (SDAP), and/or Packet Data Convergence Protocol (PDCP) sublayers of the RAN. The DU is a logical Node hosting Radio Link Control (RLC), Media Access Control (MAC), and Physical (PHY) sublayers of the RAN. The RU is a physical Node that converts radio signals from antennas to digital signals that can be transmitted over the FrontHaul to a DU. Because these entities have open protocols and interfaces between them, they can be developed by different vendors.

FIG. 1 illustrates a related art O-RAN architecture. Referring to FIG. 1, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (Non-RT RIC) and a near-real-time RIC (Near-RT RIC).

The Non-RT RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., Near-RT RIC, O-RAN centralized Unit (O-CU), O-RAN Distributed Unit (O-DU), etc.).

The Near-RT RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The Near-RT RIC uses the E2 interface to control the underlying RAN elements (E2 Nodes/network functions (NFs)) over a near-real-time control loop. The Near-RT RIC monitors, suspends/stops, overrides, and controls the E2 Nodes (O-CU, O-DU, and O-eNB) via policies. For example, the Near-RT sets policy parameters on activated functions of the E2 Nodes. Further, the Near-RT RIC hosts xApps to implement functions such as quality of service (QoS) optimization, mobility optimization, slicing optimization, interference mitigation, load balancing, security, etc. The two types of RICs work together to optimize the O-RAN. For example, the Non-RT RIC provides, over the A1 interface, the policies, data, and AI/ML models enforced and used by the Near-RT RIC for RAN optimization, and the Near-RT returns policy feedback (i.e., how the policy set by the NON-RT RIC works).

The SMO framework, within which the Non-RT RIC is located, manages and orchestrates RAN elements. Specifically, the SMO includes the Federated O-Cloud Orchestration and Management (FOCOM), a Network Function Orchestrator (NFO) that manages Virtual Machines (VM) based Virtual Network Functions (VNF) and container (i.e., instance) based VNF (CNF), and the OAM as a part of the SMO that manages and orchestrates what is referred to as the O-RAN Cloud (O-Cloud). The O-Cloud is a collection of physical RAN Nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides Infrastructure Management Services (IMS) and Deployment Management Services (DMS). The O2 interface may also send O2 telemetry data to the SMO, e.g., O-Cloud configuration or any logical function data, energy consumption, health status of Node, etc.

### SUMMARY

In the related art, NF's (which may be implemented as VNF's and CNF's) run as microservices which require data that may be sensitive in nature (for example, private keys, access tokens, passwords, and configuration data). During the bootstrap of such NF's, the data may be provided by a microservice run-time engine (e.g., a VNF/CNF run-time engine of O-Cloud, which may by referred herein below as a “O-Cloud run-time engine”), by mounting the data as a virtual storage drive in the micro service.

Accordingly, a NF which is running as a microservice during the bootstrapping may use the data from the virtual drive according to programmed logic. However, related art systems do not have any policy-based mechanisms for erasing or unmounting sensitive data from the NF microservice. Thus, any sensitive data which may remain in the presence of the NF service after use may introduce a security risk for the overall network by increasing the attack surface of the NF.

Furthermore, related art systems do not have any method of alerting a NF of a potential breach in the O-Cloud so that the NF can take precautionary actions to improve its security and reduce the attack surface. Accordingly, there is a need for a policy-based approach for securely handling data volumes in relation to NF's, and providing them with notifications.

Example embodiments of the present disclosure provide a method and system for policy-based data management in an Open Radio Access Network (O-RAN) Cloud (O-Cloud) infrastructure. In particular, the method may include: storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and performing, by the O-Cloud infrastructure, the at least one action based on the data policy. Accordingly, embodiments may allow for sensitive data involved in bootstrapping for NF's to be securely handled in a policy-based manner, and NF's may receive notifications which may be used in order to pre-emptively reduce their attack surface.

According to embodiments, an apparatus for policy-based data management in an Open Radio Access Network (O-RAN) Cloud (O-Cloud) infrastructure may be provided, wherein the apparatus is configured to: store, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and perform, by the O-Cloud infrastructure, the at least one action based on the data policy.

According to embodiments, a non-transitory computer-readable recording medium may be provided, having recorded thereon instructions to perform a method including: storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and performing, by the O-Cloud infrastructure, the at least one action based on the data policy.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

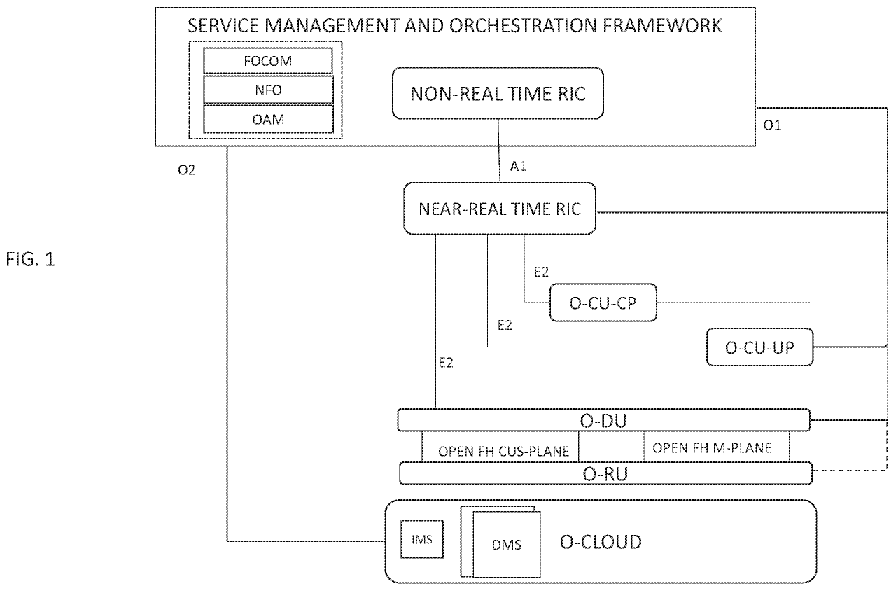

FIG. 2 illustrates a system architecture diagram according to an embodiment;

FIG. 3 illustrates a flowchart of a method for managing a data volume according to an embodiment;

FIG. 4 illustrates a diagram of an example environment in which systems and/or methods, described herein, may be implemented; and

FIG. 5 illustrates a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system for policy-based data management in an Open Radio Access Network (O-RAN) Cloud (O-Cloud) infrastructure. In particular, the method may include: storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and performing, by the O-Cloud infrastructure, the at least one action based on the data policy. Accordingly, embodiments may allow for sensitive data involved in bootstrapping for NF's to be securely handled in a policy-based manner, and NF's may receive notifications which may be used in order to pre-emptively reduce their attack surface.

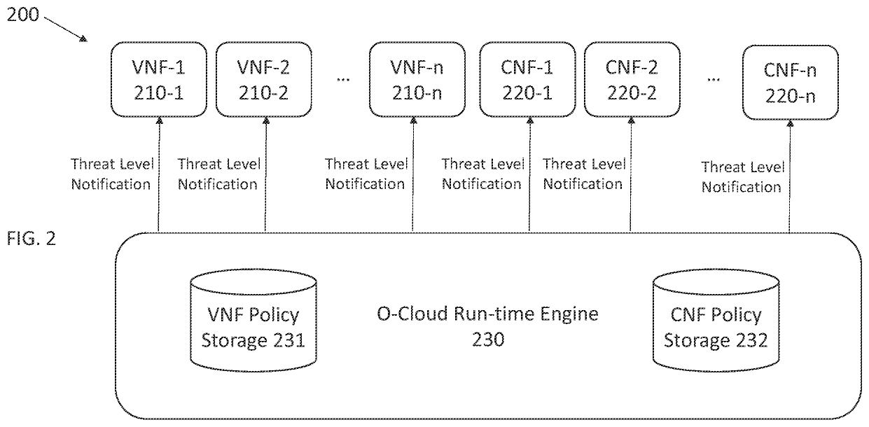

FIG. 2 illustrates a system architecture diagram of system 200 according to an embodiment.

Referring to FIG. 2, a plurality of virtual network functions (VNF)'s 210 (VNF-1 210-1, VNF-2 210-2, . . . VNF-N 210-N) and container-based VNF's (CNF)'s 220 (CNF-1 220-1, CNF-2 220-2, . . . CNF-N 220-N) may be provided in system 200. VNF's 210 and CNF's 220 may receive threat level notifications from O-Cloud run-time engine 230.

O-Cloud run-time engine 230 may be responsible for managing VNF's/CNF's (i.e., each of VNF's 210 and CNF's 220). According to some embodiments, this may be a dedicated run-time engine only for managing VNF's/CNF's, or it may include functionality for handling other operations depending on the specific implementation. The O-Cloud run-time engine 230 may operate within the O-Cloud infrastructure. The O-Cloud run-time engine 230 may provide the run-time environment needed for VNF's 210 and CNF's 220, including mounting sensitive data volumes as files in the file-system, or environment variables during bootstrapping.

O-Cloud run-time engine 230 may include VNF policy storage 231 and CNF policy storage 232, which may be used to store policies related to handling data volumes in relation to VNF's 210 and CNF's 220 respectively. These policies may specifically be related to handling sensitive data, according to embodiments.

According to embodiments, a VNF/CNF policy (which may also be referred to as a “NF policy” hereinbelow) may include rules which indicate how to handle sensitive data. These rules may define actions which may be performed on a per VNF/CNF basis including, but not necessarily limited to, unmounting, remounting, and notifying VNF/CNF's for sensitive data management.

For example, a NF policy for unmount actions may define rules and/or criteria which may be used for unmounting a particular data volume (which may have previously been mounted by O-Cloud run-time engine 230).

According to some embodiments, policies may include rules for unmount actions which are time-based, wherein a time-based unmount rule can be used to unmount a virtual data volume, or un-set environment variables of the particular virtual data volume after a pre-defined period of time. Accordingly, VNF's 210 and CNF's 220 may have ample time to read the needed information from the data volume as well as any environment variables during bootstrapping, and the data volume will be unmounted based on the time-based rule thereafter.

According to some embodiments, policies may include rules for unmount actions which may include an interactive shell rule, wherein unmount and/or un-set actions can be performed by the O-Cloud (e.g., an operator) as a preliminary step before allowing an interactive shellrequest to the VNF's 210 and CNF's 220 is honored.

According to some embodiments, the policies may include a rule based on the NF state (e.g., which may be determined as a result of a liveness probe) as criteria for performing unmount actions.

According to some embodiments, the policies may include a rule/action wherein the NF may invoke a specific O-Cloud API(s) to request the unmount action.

According to some embodiments, any custom criteria may be defined as a place-holder rule, which may customized during deployment (using well-defined syntax) in order to include any custom logic to perform the unmount operation. By means of non-limiting example, a custom criteria could be defined based on the existence of a specific file in the file-system. As another example, a threat hunting script may indicate that there is a high level of threat, which may also be used as a criteria for unmounting the volume.

It should be appreciated that the above list of rules for unmounting actions for policies can be performed simultaneously or mutually exclusive, and that other rules and/or criteria which are not mentioned may also be performed, depending on the specific implementation.

Conversely, remount actions may be performed by O-Cloud run-time engine 230 based on policies. These may include remount actions which define rules/criteria for remounting a particular data volume which was previous unmounted by the O-Cloud run-time engine 230.

According to some embodiments, a rule for remounting may simply define whether remounting is allowed for a previously unmounted volume or not.

According to some embodiments, the policies may include a rule/action wherein the NF may invoke a specific O-Cloud API(s) to request the remount action.

According to some embodiments, any custom criteria may be defined as a place-holder rule, which may be customized during deployment (using well-defined syntax) in order to include any custom logic to perform the remount operation. By means of non-limiting example, a custom criteria could be defined based on the existence of a specific file in the file-system. As another example, a threat hunting script may indicate that there is a low level of threat, which may also be used as a criteria for remounting the volume.

It should be appreciated that the above list of rules for remounting actions for policies can be performed simultaneously or mutually exclusive, and that other rules and/or criteria which are not mentioned may also be performed, depending on the specific implementation.

A rule for sending a notification to a specific VNF/CNF may be configured on a per-NF and/or per data volume basis may also be defined in the policies. In particular, these notifications may indicate a security of a perceived dynamic threat level which is detected by O-cloud run-time engine 230 (either directly detected, or indirectly detected). According to some embodiments, based on receiving such notifications, the VNF's 210 and/or CNF's 220 may take appropriate actions in response to a high perceived threat level to shield itself and reduce attack surface. By means of non-limiting example, a VNF/CNF could remove sensitive data from its memory/cache and retrieve the information only on a demand basis from secure storage. It should be appreciated that other security actions can be taken by VNF's 210 and/or CNF's 220, depending on the specific implementation.

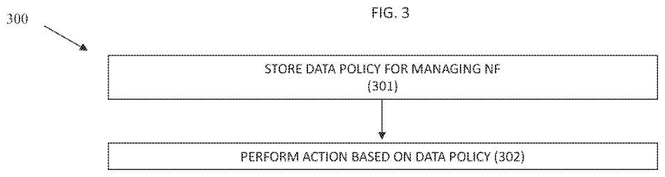

FIG. 3 illustrates a flowchart of a method for managing a data volume according to an embodiment.

At operation 301, the O-Cloud infrastructure may store a data policy for managing a network function (NF) (e.g., any one of VNF's 210 and/or CNF's 220 with reference to FIG. 2 above) deployed on the O-Cloud infrastructure. According to embodiments, the data policy may define rules which control how to handle sensitive data in the data volume. According to some embodiments, the data volume may specifically be a sensitive data volume. The data policy may comprise definitions for at least one action from among an unmount action, a remount action and a notification action for notifying the NF of a security threat.

As an example, for the unmount action, the definition may include at least one of a time-based unmount rule defining a time to perform the unmount action, an interactive shell rule defining whether the unmount action is to be performed before an interactive shell request to the NF is honored, an NF state rule indicating whether a state of the NF is to be considered to perform the unmount action; and an NF request rule indicating whether the unmount action is requestable by the NF.

As another example, for the remount action, the definition may include at least one of an allow rule defining whether the remount action is permitted for a previously unmounted data volume and an NF request rule indicating whether the remount action is requestable by the NF.

As yet another example, for the notification action, the definition may indicate whether a security notification for the data volume is enabled, and the security notification indicating a perceived dynamic threat level from the O-Cloud infrastructure to the NF.

It should be appreciated that operation 301 may more specifically be performed by an O-Cloud run-time engine (e.g., O-Cloud run-time engine 230 with reference to FIG. 2 above). The data policy may be stored in a policy storage located in the O-Cloud run-time engine (e.g., VNF Policy storage 231 and/or CNF Policy storage 232). The O-Cloud infrastructure may store a plurality of data policies on a per-NF basis. The data policies may also defines the at least one action for a plurality of data volumes that mount sensitive data to the NF (e.g., it may be applied to more than one data volumes).

At operation 302, the O-Cloud infrastructure may perform the at least one action based on the data policy. It should be appreciated that operation 302 may more specifically be performed by an O-Cloud run-time engine (e.g., O-Cloud run-time engine 230 with reference to FIG. 2 above).

Based on the above, it can be understood that example embodiments may allow for sensitive data involved in bootstrapping for NF's to be securely handled in a policy-based manner, and NF's may receive notifications which may be used in order to pre-emptively reduce their attack surface.

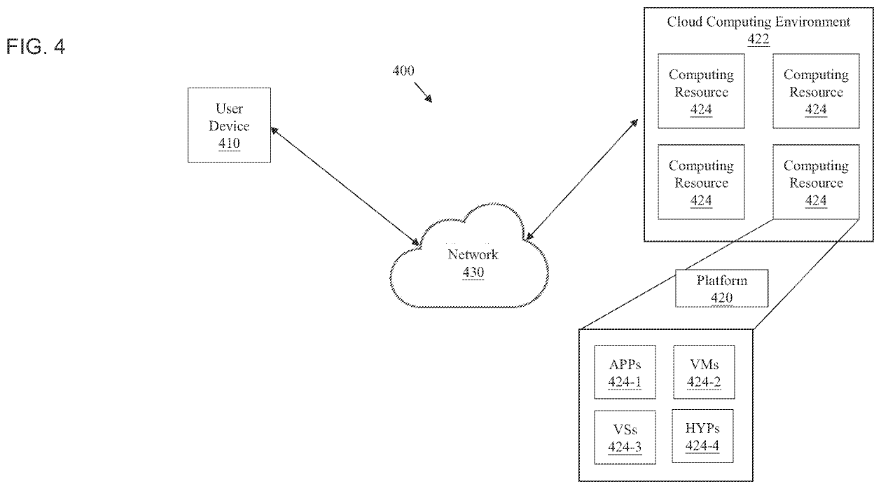

FIG. 4 is a diagram of an example environment 400 in which systems and/or methods, described herein, may be implemented. As shown in FIG. 4, environment 400 may include a user device 410, a platform 420, and a network 430. Devices of environment 400 may interconnect via wired connections, wireless connections, or a combination of wired and wireless connections. In embodiments, any of the functions and operations described with reference to FIGS. 2 through 4 above may be performed by any combination of elements illustrated in FIG. 4.

User device 410 includes one or more devices capable of receiving, generating, storing, processing, and/or providing information associated with platform 420. For example, user device 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 410 may receive information from and/or transmit information to platform 420.

Platform 420 includes one or more devices capable of receiving, generating, storing, processing, and/or providing information. In some implementations, platform 420 may include a cloud server or a group of cloud servers. In some implementations, platform 420 may be designed to be modular such that certain software components may be swapped in or out depending on a particular need. As such, platform 420 may be easily and/or quickly reconfigured for different uses.

In some implementations, as shown, platform 420 may be hosted in cloud computing environment 422. Notably, while implementations described herein describe platform 420 as being hosted in cloud computing environment 422, in some implementations, platform 420 may not be cloud-based (i.e., may be implemented outside of a cloud computing environment) or may be partially cloud-based.

Cloud computing environment 422 includes an environment that hosts platform 420. Cloud computing environment 422 may provide computation, software, data access, storage, etc., services that do not require end-user (e.g., user device 410) knowledge of a physical location and configuration of system(s) and/or device(s) that hosts platform 420. As shown, cloud computing environment 422 may include a group of computing resources 424 (referred to collectively as “computing resources 424” and individually as “computing resource 424”).

Computing resource 424 includes one or more personal computers, a cluster of computing devices, workstation computers, server devices, or other types of computation and/or communication devices. In some implementations, computing resource 424 may host platform 420. The cloud resources may include compute instances executing in computing resource 424, storage devices provided in computing resource 424, data transfer devices provided by computing resource 424, etc. In some implementations, computing resource 424 may communicate with other computing resources 424 via wired connections, wireless connections, or a combination of wired and wireless connections.

As further shown in FIG. 4, computing resource 424 includes a group of cloud resources, such as one or more applications (“APPs”) 424-1, one or more virtual machines (“VMs”) 424-2, virtualized storage (“VSs”) 424-3, one or more hypervisors (“HYPs”) 424-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components (e.g., nodes, E2 nodes, SMO functions, RIC, system, apparatus, etc.) may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes

Application 424-1 includes one or more software applications that may be provided to or accessed by user device 410. Application 424-1 may eliminate a need to install and execute the software applications on user device 410. For example, application 424-1 may include software associated with platform 420 and/or any other software capable of being provided via cloud computing environment 422. In some implementations, one application 424-1 may send/receive information to/from one or more other applications 424-1, via virtual machine 424-2.

Virtual machine 424-2 includes a software implementation of a machine (e.g., a computer) that executes programs like a physical machine. Virtual machine 424-2 may be either a system virtual machine or a process virtual machine, depending upon use and degree of correspondence to any real machine by virtual machine 424-2. A system virtual machine may provide a complete system platform that supports execution of a complete operating system (“OS”). A process virtual machine may execute a single program, and may support a single process. In some implementations, virtual machine 424-2 may execute on behalf of a user (e.g., user device 410), and may manage infrastructure of cloud computing environment 422, such as data management, synchronization, or long-duration data transfers.

Virtualized storage 424-3 includes one or more storage systems and/or one or more devices that use virtualization techniques within the storage systems or devices of computing resource 424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 424-4 may provide hardware virtualization techniques that allow multiple operating systems (e.g., “guest operating systems”) to execute concurrently on a host computer, such as computing resource 424. Hypervisor 424-4 may present a virtual operating platform to the guest operating systems, and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

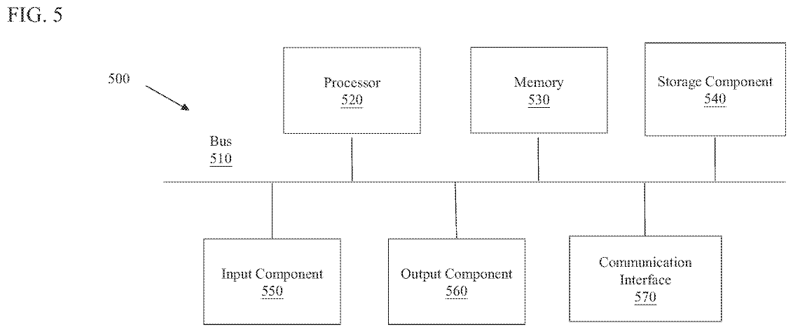

FIG. 5 is a diagram of example components of a device 500. Device 500 may correspond to user device 410 and/or platform 420. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 may be implemented in hardware, firmware, or a combination of hardware and software. Processor 520 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, or the like.

Device 500 may perform one or more processes described herein. Device 500 may perform these processes in response to processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

In embodiments, any of the operations or processes of FIGS. 2-3 may be implemented by or using any one of the elements illustrated in FIGS. 4 and 5. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

These computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:

Item [1] A method for policy-based data management in an Open Radio Access Network (O-RAN) Cloud (O-Cloud) infrastructure, the method including: storing, by the O-Cloud infrastructure, a data policy for managing a network function (NF) deployed on the O-Cloud infrastructure, the data policy comprising definitions for at least one action from among an unmount action, a remount action and a notification action for notifying the NF of a security threat; and performing, by the O-Cloud infrastructure, the at least one action based on the data policy.

Item [2] The method according to item [1], wherein the data volume is a sensitive data volume.

Item [3] The method according to any one of items [1]-[2], wherein the O-Cloud infrastructure stores a plurality of data policies on a per-NF basis.

Item [4] The method according to any one of items [1]-[3], wherein the performing the at least one action is performed by an O-Cloud NF runtime engine.

Item [5] The method according to any one of items [1]-[4], wherein the definitions comprise at least one definition for the unmount action, the at least one definition comprising at least one of: a time-based unmount rule defining a time to perform the unmount action; an interactive shell rule defining whether the unmount action is to be performed before an interactive shell request to the NF is honored; an NF state rule indicating whether a state of the NF is to be considered to perform the unmount action; and an NF request rule indicating whether the unmount action is requestable by the NF.

Item [6] The method according to any one of items [1]-[5], wherein the definitions comprise at least one definition for the remount action, the at least one definition comprising at least one of: an allow rule defining whether the remount action is permitted for a previously unmounted data volume; and an NF request rule indicating whether the remount action is requestable by the NF.

Item [7] The method according to any one of items [1]-[6], wherein the definitions comprise a definition for the notification action, the definition indicating whether a security notification for the data volume is enabled, and the security notification indicating a perceived dynamic threat level from the O-Cloud infrastructure to the NF.

Item [8] An apparatus for policy-based data management in an Open Radio Access Network (O-RAN) Cloud (O-Cloud) infrastructure, wherein the apparatus is configured to:
store, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and perform, by the O-Cloud infrastructure, the at least one action based on the data policy.

Item [9] The apparatus according to item [8], wherein the data volume is a sensitive data volume.

Item [10] The apparatus according to any one of items [8]-[9], wherein the O-Cloud infrastructure stores a plurality of data policies on a per-NF basis.

Item [11] The apparatus according to any one of items [8]-[10], wherein the performing the at least one action is performed by an O-Cloud NF runtime engine.

Item [12] The apparatus according to any one of items [8]-[11], wherein the definitions comprise at least one definition for the unmount action, the at least one definition comprising at least one of: a time-based unmount rule defining a time to perform the unmount action; an interactive shell rule defining whether the unmount action is to be performed before an interactive shell request to the NF is honored; an NF state rule indicating whether a state of the NF is to be considered to perform the unmount action; and an NF request rule indicating whether the unmount action is requestable by the NF.

Item [13] The apparatus according to any one of items [8]-[12], wherein the definitions comprise at least one definition for the remount action, the at least one definition comprising at least one of: an allow rule defining whether the remount action is permitted for a previously unmounted data volume; and an NF request rule indicating whether the remount action is requestable by the NF.

Item [14] The apparatus according to any one of items [8]-[13], wherein the definitions comprise a definition for the notification action, the definition indicating whether a security notification for the data volume is enabled, and the security notification indicating a perceived dynamic threat level from the O-Cloud infrastructure to the NF.

Item [15] A non-transitory computer-readable recording medium having recorded thereon instructions to perform a method including: storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and performing, by the O-Cloud infrastructure, the at least one action based on the data policy.

Item [16] The non-transitory computer-readable recording medium according to item [15], wherein the data volume is a sensitive data volume.

[17] Item The non-transitory computer-readable recording medium according to any one of items [15]-[16], wherein the O-Cloud infrastructure stores a plurality of data policies on a per-NF basis.

Item [18] The non-transitory computer-readable recording medium according to any one of items [15]-[17], wherein the performing the at least one action is performed by an O-Cloud NF runtime engine.

Item [19] The non-transitory computer-readable recording medium according to any one of items [15]-[18], wherein the definitions comprise at least one definition for the unmount action, the at least one definition comprising at least one of: a time-based unmount rule defining a time to perform the unmount action; an interactive shell rule defining whether the unmount action is to be performed before an interactive shell request to the NF is honored; an NF state rule indicating whether a state of the NF is to be considered to perform the unmount action; and an NF request rule indicating whether the unmount action is requestable by the NF.

Item [20] The non-transitory computer-readable recording medium according to any one of items [15]-[19], wherein the definitions comprise at least one definition for the remount action, the at least one definition comprising at least one of: an allow rule defining whether the remount action is permitted for a previously unmounted data volume; and an NF request rule indicating whether the remount action is requestable by the NF.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for policy-based data management in an Open Radio Access Network (O-RAN) Cloud (O-Cloud) infrastructure, the method comprising:
storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and
performing, by the O-Cloud infrastructure, the at least one action based on the data policy.

2. The method as claimed in claim 1, wherein the data volume is a sensitive data volume.

3. The method as claimed in claim 1, wherein the O-Cloud infrastructure stores a plurality of data policies on a per-NF basis.

4. The method as claimed in claim 1, wherein the performing the at least one action is performed by an O-Cloud NF runtime engine.

5. The method as claimed in claim 1, wherein the definitions comprise at least one definition for the unmount action, the at least one definition comprising at least one of:
a time-based unmount rule defining a time to perform the unmount action;
an interactive shell rule defining whether the unmount action is to be performed before an interactive shell request to the NF is honored;
an NF state rule indicating whether a state of the NF is to be considered to perform the unmount action; and
an NF request rule indicating whether the unmount action is requestable by the NF.

6. The method as claimed in claim 1, wherein the definitions comprise at least one definition for the remount action, the at least one definition comprising at least one of:
an allow rule defining whether the remount action is permitted for a previously unmounted data volume; and
an NF request rule indicating whether the remount action is requestable by the NF.

7. The method as claimed in claim 1, wherein the definitions comprise a definition for the notification action, the definition indicating whether a security notification for the data volume is enabled, and the security notification indicating a perceived dynamic threat level from the O-Cloud infrastructure to the NF.

8. A system for policy-based data management in an Open Radio Access Network (O-RAN) Cloud (O-Cloud) infrastructure, the system comprising:
the O-Cloud infrastructure configured to:
store a data policy for managing a network function (NF) deployed on the O-Cloud infrastructure, the data policy comprising definitions for at least one action, with respect to a data volume, from among an unmount action, a remount action and a notification action for notifying the NF of a security threat; and
perform the at least one action based on the data policy.

9. The system as claimed in claim 8, wherein the data volume is a sensitive data volume.

10. The system as claimed in claim 8, wherein the O-Cloud infrastructure is configured to store a plurality of data policies on a per-NF basis.

11. The system as claimed in claim 8, wherein the O-Cloud infrastructure comprises an O-Cloud NF runtime engine configured to perform the at least one action.

12. The system as claimed in claim 8, wherein the definitions comprise at least one definition for the unmount action, the at least one definition comprising at least one of:
a time-based unmount rule defining a time to perform the unmount action;
an interactive shell rule defining whether the unmount action is to be performed before an interactive shell request to the NF is honored;
an NF state rule indicating whether a state of the NF is to be considered to perform the unmount action; and
an NF request rule indicating whether the unmount action is requestable by the NF.

13. The system as claimed in claim 8, wherein the definitions comprise at least one definition for the remount action, the at least one definition comprising at least one of:
an allow rule defining whether the remount action is permitted for a previously unmounted data volume; and
an NF request rule indicating whether the remount action is requestable by the NF.

14. The system as claimed in claim 8, wherein the definitions comprise a definition for the notification action, the definition indicating whether a security notification for the data volume is enabled, and the security notification indicating a perceived dynamic threat level from the O-Cloud infrastructure to the NF.

15. A non-transitory computer-readable recording medium having recorded thereon instructions executable by at least one computer to perform a method for policy-based data management in an Open Radio Access Network (O-RAN) Cloud (O-Cloud) infrastructure, the method comprising:
storing, by the O-Cloud infrastructure, a data policy for managing a network function (NF) deployed on the O-Cloud infrastructure, the data policy comprising definitions for at least one action, with respect to a data volume, from among an unmount action, a remount action and a notification action for notifying the NF of a security threat; and
performing, by the O-Cloud infrastructure, the at least one action based on the data policy.

16. The non-transitory computer-readable recording medium as claimed in claim 15, wherein the data volume is a sensitive data volume.

17. The non-transitory computer-readable recording medium as claimed in claim 15, wherein the O-Cloud infrastructure stores a plurality of data policies on a per-NF basis.

18. The non-transitory computer-readable recording medium as claimed in claim 15, wherein the performing the at least one action is performed by an O-Cloud NF runtime engine.

19. The non-transitory computer-readable recording medium as claimed in claim 15, wherein the definitions comprise at least one definition for the unmount action, the at least one definition comprising at least one of:
a time-based unmount rule defining a time to perform the unmount action;
an interactive shell rule defining whether the unmount action is to be performed before an interactive shell request to the NF is honored;
an NF state rule indicating whether a state of the NF is to be considered to perform the unmount action; and
an NF request rule indicating whether the unmount action is requestable by the NF.

20. The non-transitory computer-readable recording medium as claimed in claim 15, wherein the definitions comprise at least one definition for the remount action, the at least one definition comprising at least one of:
an allow rule defining whether the remount action is permitted for a previously unmounted data volume; and
an NF request rule indicating whether the remount action is requestable by the NF.
